(19) United States
(12) Patent Application Publication
(10) Pub. No.: US 2018/0065270 A1
(43) Pub. Date: Mar. 8, 2018

(54) CHAINSAW CHAIN WITH A DEFINED SURFACE HARDNESS LAYER ON CUTTER LINKS

(71) Applicant: HUSQVARNA AB, HUSKVARNA (SE)

(72) Inventor: Niklas Sarius, Jönköping (SE)

(21) Appl. No.: 15/554,502

(22) PCT Filed: Mar. 2, 2016
(86) PCT No.: PCT/IB2016/051183

§ 371 Date: Aug. 30, 2017

Related U.S. Application Data
(60) Provisional application No. 62/128,125, filed on Mar. 4, 2015.

(51) Int. Cl. B27B 33/14; B27B 17/02

(52) U.S. Cl. CPC B27B 33/142; B27B 17/02

(57) ABSTRACT

A method of modifying a cutter link (240) of cutting chain for a chainsaw may include forming the cutter link (240) to include a base portion (280) and a cutting portion (270) extending away from the base portion (280). The cutting portion (270) may include a side plate (300) and a top plate (310). The top plate (310) may include a top face (316) and a bottom face (314). The side plate (300) may include an outer face and an inside face (304). The method may further include determining a maximum non-homogeneous material hardness expected to be encountered during cutting operations, selecting a coating material having a hardness at least 1.3 times the maximum non-homogeneous material hardness, and coating a treated surface of the top plate (310) and/or the side plate (300).

### CROSS REFERENCE TO RELATED APPLICATION

This application claims priority to U.S. provisional application No. 62/128,125 filed on Mar. 4, 2015, the entire contents of which are incorporated herein by reference.

### TECHNICAL FIELD

Example embodiments generally relate to hand held power equipment and, more particularly, relate to cutting chain improvements for a chainsaw.

### BACKGROUND

Chainsaws are commonly used in both commercial and private settings to cut timber or perform other rigorous cutting operations. Because chainsaws are typically employed in outdoor environments, and the work they are employed to perform often inherently generates debris, chainsaws are typically relatively robust hand held machines. They can be powered by gasoline engines or electric motors (e.g., via batteries or wired connections) to turn a chain around a guide bar at relatively high speeds. The chain includes cutting teeth that engage lumber or another medium in order to cut the medium as the teeth are passed over a surface of the medium at high speed.

Given that the chainsaw may be employed to cut media of various sizes and types, it should be appreciated that the design of the chain itself may have an impact on the effectiveness of the cutting operations. In particular, cutter edges of the chain may wear over time. This wear occurs based on the edges being grinded or abraded by the material that the chain is cutting. For softer materials, such as wood, this wearing process may be relatively slow. However, even wood may have hardness variations at various different parts of the wood. For example, the bark may be exposed to other materials (e.g., sand, ash, dirt, etc.). Thus, if the bark has some of these particles embedded therein (e.g., by the wind or other natural forces), the wearing process may be accelerated when the chain is engaged in cutting of the bark.

As such, it may be desirable to explore a number of different chain design improvements that could be employed alone or together with other design changes to improve overall chainsaw, and cutting chain, performance. In particular, it may be desirable to improve the wear resistance of the cutting chain.

### BRIEF SUMMARY OF SOME EXAMPLES

Some example embodiments may provide for a chainsaw chain constructed with a modification to cutter links to improve cutting efficiency. The modification to the cutter links of the chain may improve cutting efficiency and minimize the energy required for executing the cutting procedure. The modification, which involves applying a coating of at least a minimum or defined hardness relative to particles that may be expected to be encountered during chain operation, may make edges of the cutter links on the chain more resistant to wear. The cutter links may therefore have better stay sharp properties and a longer useful life. Other improvements may also be possible, and the improvements can be made completely independent of each other, or in combination with each other in any desirable configuration. Accordingly, the operability and utility of the chainsaw may be enhanced or otherwise facilitated.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a side view of a chainsaw according to an example embodiment;

FIG. 2 illustrates a side view of a chainsaw guide bar employing a chain according to an example embodiment;

FIG. 3 illustrates a perspective side view of one cutter link in accordance with an example embodiment; and

FIG. 4 illustrates a block diagram of a method of treating a cutter link in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

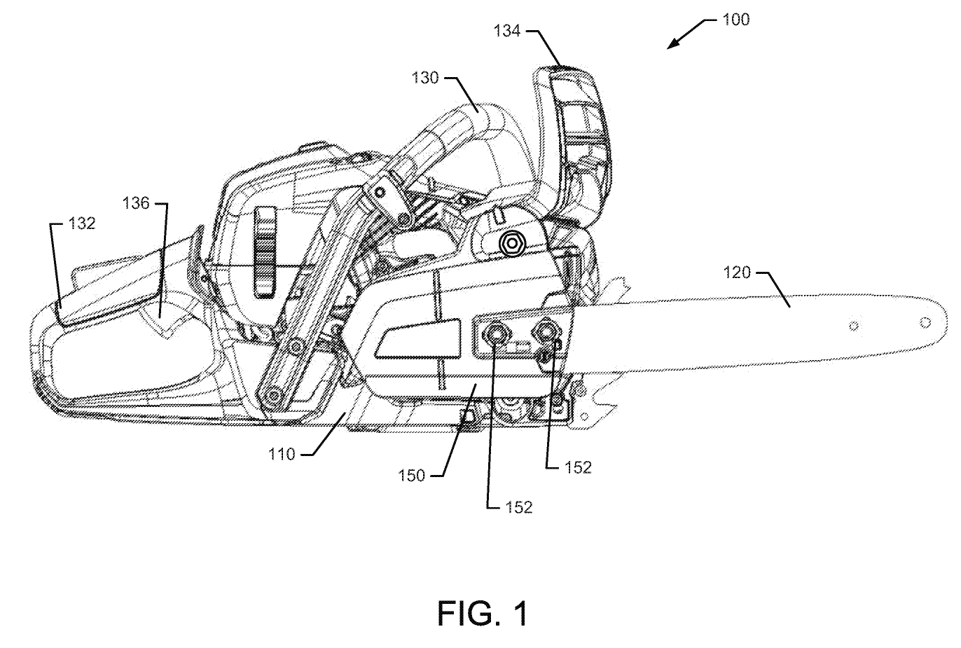

FIG. 1 illustrates side view of a chainsaw 100 according to an example embodiment. As shown in FIG. 1, the chainsaw 100 may include a housing 110 inside which a power unit or motor (not shown) is housed. In some embodiments, the power unit may be either an electric motor or an internal combustion engine. Furthermore, in some embodiments, the power unit may include more than one electric motor where one such electric motor powers the working assembly of the chainsaw 100 and the other electric motor of the power unit powers a pump that lubricates the working assembly or provides momentum for moving other working fluids within the chainsaw 100. The chainsaw 100 may further include a guide bar 120 that is attached to the housing 110 along one side thereof. A chain (not shown) may be driven around the guide bar 120 responsive to operation of the power unit in order to enable the chainsaw 100 to cut lumber or other materials. The guide bar 120 and the chain may form the working assembly of the chainsaw 100. As such, the power unit may be operably coupled to the working assembly to turn the chain around the guide bar 120.

The chainsaw 100 may include a front handle 130 and a rear handle 132. A chain brake and front hand guard 134 may be positioned forward of the front handle 130 to stop the movement of the chain 122 in the event of a kickback. In an example embodiment, the hand guard 134 may be tripped by rotating forward in response to contact with a portion of the arm (e.g., the hand/wrist) of the operator of the chainsaw 100. In some cases, the hand guard 134 may also be tripped in response to detection of inertial measurements indicative of a kickback.

The rear handle 132 may include a trigger 136 to facilitate operation of the power unit when the trigger 136 is actuated. In this regard, for example, when the trigger 136 is actuated (e.g., depressed), the rotating forces generated by the power unit may be coupled to the chain either directly (e.g., for electric motors) or indirectly (e.g., for gasoline engines). The term “trigger,” as used herein, should be understood to represent any actuator that is capable of being operated by a hand or finger of the user. Thus, the trigger 136 may represent a button, switch, or other such component that can be actuated by a hand or portion thereof.

Some power units may employ a clutch to provide operable coupling of the power unit to a sprocket that turns the chain. In some cases (e.g., for a gasoline engine), if the trigger 136 is released, the engine may idle and application of power from the power unit to turn the chain may be stopped. In other cases (e.g., for electric motors), releasing the trigger 136 may secure operation of the power unit. The housing 110 may include a fuel tank for providing fuel to the power unit. The housing 110 may also include or at least partially define an oil reservoir, access to which may be provided to allow the operator to pour oil into the oil reservoir. The oil in the oil reservoir may be used to lubricate the chain as the chain is turned.

As can be appreciated from the description above, actuation of the trigger 136 may initiate movement of the chain around the guide bar 120. A clutch cover 150 may be provided to secure the guide bar 120 to the housing 110 and cover over the clutch and corresponding components that couple the power unit to the chain (e.g., the sprocket and clutch drum). As shown in FIG. 1, the clutch cover 150 may be attached to the body of the chainsaw 100 (e.g., the housing 110) via nuts 152 that may be attached to studs that pass through a portion of the guide bar 120. The guide bar 120 may also be secured with the tightening of the nuts 152, and a tightness of the chain can be adjusted based on movement of the guide bar 120 and subsequent tightening of the nuts 152 when the desired chain tightness is achieved. However, other mechanisms for attachment of the clutch cover 150 and/or the guide bar 120 may be provided in other embodiments including, for example, some tightening mechanisms that may combine to tighten the chain in connection with clamping the guide bar 120.

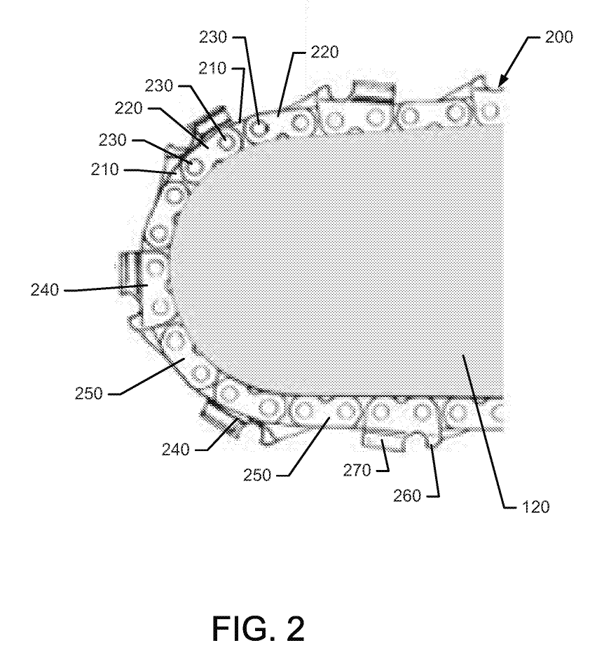

In some embodiments, the guide bar 120 may be formed from two laminate core sheets that lie in parallel planes along side each other to define a channel around a periphery of the guide bar 120. The chain (or at least a portion of the chain) may ride in the channel, as the rest of the chain rides along the periphery of the guide bar 120 to engage media for cutting. FIG. 2 illustrates a typical chain 200 disposed on the guide bar 120. The chain 200 includes a plurality of center drive links 210 that each include a portion thereof that rides in the channel. Each center drive link 210 is attached to an adjacent pair of side links 220 by rivets 230 that extend perpendicular to the longitudinal length of the links. A rivet 230 is provided at the front portion of each center drive link 210 to attach the center drive link 210 to the rear portion of a preceding side links 220 and another rivet 230 is provided at the rear portion of each center drive link 210 to attach the center drive link 210 to the front portion of a subsequent side links 220. As such, each pair of side links 220 connects to opposing sides of the center drive links 210, and the connections are repeated in alternating fashion to complete a circular or endless chain.

For some pairs of side links 220 of the chain 200 one of the side links may be formed as a cutter link 240. Meanwhile, pairs of side links that do not include a cutter link 240 may be referred to as tie links 250. The cutter links 240 may be provided with two portions including a depth gauge portion 260 and a cutting portion 270. The cutting portion 270 may generally engage material that extends beyond the depth of the depth gauge portion 260 when the chain 200 is rotated. Meanwhile, the tie links 250 may not include cutting portions or depth gauge portions and may be provided to simply extend the length of the chain 200 while providing a space between portions of the chain 200 that will create friction during cutting operations. If every side link 210 was a cutter link 240, the friction on the chain 200 would be very high, and it would be difficult to provide sufficient power to turn the chain, and control of the chainsaw 100 could also become difficult.

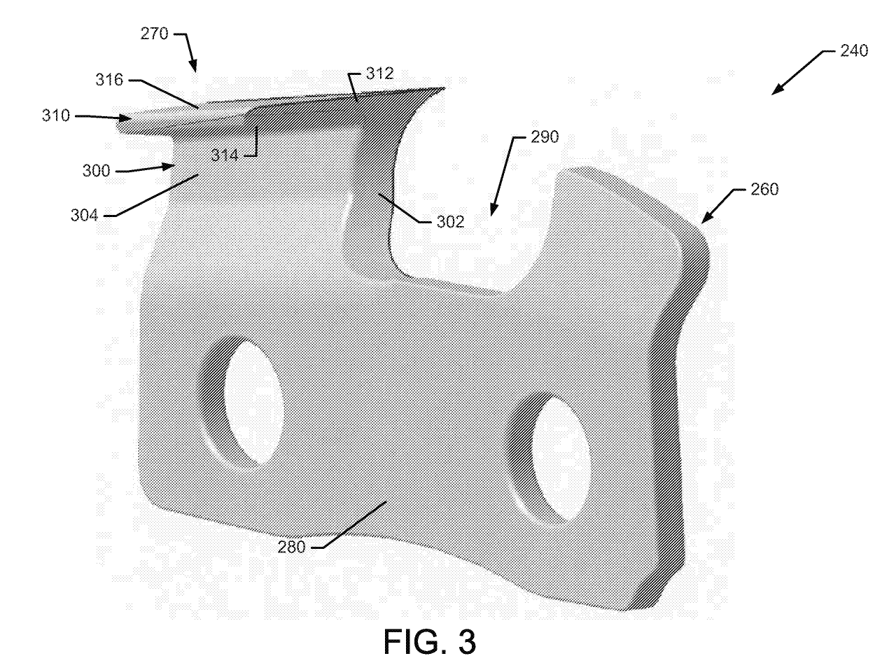

As shown in FIG. 3, the cutter links 240 may have a base portion 280 from which both the cutting portion 270 and the depth gauge portion 260 extend. The rivets may be passed through holes in the base portion 280. The cutting portion 270 may extend away from the base portion 280 in the same direction that the depth gauge portion 260 extends away from the base portion 280. However, the depth gauge portion 260 may be at one end of the cutter link 240 and the cutting portion 270 may be at the other end, separated from each other by a gap 290. Of note, the gap 290 may grow in size over time, as the cutting portion 270 is worn or abraded away due to use.

The cutting portion 270 may include a side plate 300 that extends upward away from the base portion 280. Although the side plate 300 generally extends in a direction parallel to plane in which the base portion 280 lies, the side plate 300 does not necessarily also lie in the same plane. In some cases, the side plate 300 may have a curved shape to bend slightly out of the plane. Moreover, in some embodiments, the side plate 300 may bend out of the plane and then back toward the plane as it extends away from the base portion 280. Regardless, the distal end of the side plate 300 may be joined with a top plate 310. The top plate 310 may lie in a plane that is substantially perpendicular to the plane in which the base portion 280 lies.

The side plate 300 may have a leading edge 302 and an inside face 304. The side plate may also have an outside face that is opposite the inside face 304, and a trailing edge that is opposite the leading edge 302. The top plate 310 may have a leading edge 312 that extends substantially perpendicular to the direction of extension of the base 280 (and in some cases also the direction of extension of the leading edge 302 of the side plate 300). The top plate 310 may also have a bottom face 314 and a top face 316. The top face 316 may be opposite the bottom face 314 and, in some cases, the top and bottom faces 316 and 314 may be in parallel planes. However, in some cases, the top and bottom faces 316 and 314 may be angled slightly toward each other as they extend away from the side plate 300. The top plate 310 may also have a trailing edge disposed opposite the leading edge 312.

In an example embodiment, the cutter link 240 may be formed by stamping, grinding and combinations thereof with or without other techniques also being employed. To execute a modification of the cutter link 240 in accordance with an example embodiment, the cutter link 240 may be treated after its initial formation in order to apply a coating material onto portions of the top face 316 of the top plate 310 and/or outside face of the side plate 300. However, the coating may have at least a defined surface layer hardness. In this regard, for example, the coating may be applied to have a harness of at least 1.3 times the expected hardness of embedded particles that may be encountered. In the example described above, sand, dirt, ash, etc., can have a hardness of around 1000 Hv (thus 1300 Hv or higher hardness for the surface layer would be targeted). In some cases, silica/quarts particles are the most common particles can have a hardness of about 800-1200 Hv). Accordingly, the coating may be selected to have at least 1.3 times the greatest hardness (e.g., 1000 Hv), and therefore the coating may be selected to have a hardness preferably greater than 1500 Hv (e.g., 1300 Hv or higher).

By employing the defined surface layer hardness for the coating to be applied, a harness interval may be maintained relative to any expected non-homogeneous material that may be encountered during the cutting process. Some example materials that may be selected include but are not limited to TiAlN based coatings with about 3300 Hv Microhardness (Hv 0.05), CrN based coatings with about 1750 Hv Microhardness (Hv 0.05), or AlCrN based coatings with about 3200 Hv Microhardness (Hv 0.05). In some cases other treatments, such as laser impregnated surfaces, may be applied. As an example, WC particles may be melted down into the surface with a laser to form a matrix of steel with WC particles (hardness approximately 3200 Hv), or TiC particles melted down into the surface with a laser to form a matrix of steel with TiC particles (hardness approximately 2200 Hv). Some coatings/treatments may be hardened after application of the corresponding coatings/treatments.

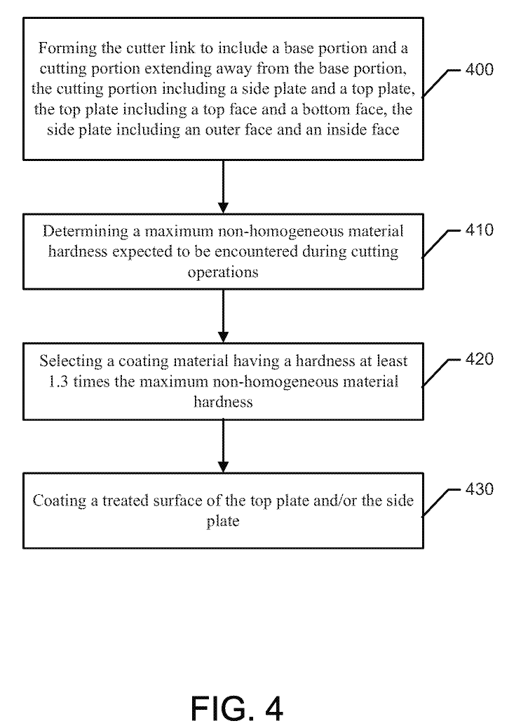

FIG. 4 illustrates a block diagram of a method of modifying a cutter link of cutting chain for a chainsaw. The method may include forming the cutter link to include a base portion and a cutting portion extending away from the base portion at operation 400. The cutting portion may include a side plate and a top plate. The top plate may include a top face and a bottom face. The side plate may include an outside face and an inside face. The method may further include determining a maximum non-homogeneous material hardness expected to be encountered during cutting operations at operation 410, selecting a coating material having a hardness at least 1.3 times the maximum non-homogeneous material hardness at operation 420, and coating a treated surface of the top plate and/or the side plate at operation 430. In some embodiments, however, the coating may be further employed on other surfaces at which wear is expected. For example, a coating material having increased hardness may also be applied to surfaces of the chain that contact other chain parts or the guide bar, portions of the chain that contact the nose sprocket or the drive sprocket, and/or the like.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A cutting chain for a chainsaw, the chain comprising:
a plurality of drive links; and
a plurality of cutter links operably coupled to respective ones of the drive links,
wherein at least one of the cutter links comprises:
a base portion; and
a cutting portion extending away from the base portion, the cutting portion including a side plate and a top plate, the top plate including a top face and a bottom face, the side plate including an outer face and an inside face,
wherein the side plate and/or the top plate is coated with a material having a hardness at least 1.3 times greater than a maximum non-homogeneous material hardness expected to be encountered during cutting operations.

2. The cutting chain of claim 1, wherein the coating material comprises a hardness at least 1300 Hv.

3. The cutting chain of claim 2, wherein the coating material comprises a hardness at least 1500 Hv.

4. The cutting chain of claim 2, wherein the treated surface comprises the outside face of the side plate.

5. The cutting chain of claim 2, wherein the treated surface comprises the top face of the top plate.

6. The cutting chain of claim 2, wherein the treated surface comprises both the outside face of the side plate and the top face of the top plate (310).

7. The cutting chain of claim 2, wherein the coating material is further applied to a portion of the base portion that is in contact with another portion of the cutting chain.

8. The cutting chain of claim 2, wherein the coating material is further applied to a portion of the base portion that is in contact with a guide bar of the chainsaw.

9. A method of modifying a cutter link of cutting chain for a chainsaw, the method comprising:
forming the cutter link to include a base portion and a cutting portion extending away from the base portion, the cutting portion including a side plate and a top plate, the top plate including a top face and a bottom face, the side plate including an outer face and an inside face; and
determining a maximum non-homogeneous material hardness expected to be encountered during cutting operations;
selecting a coating material having a hardness at least 1.3 times the maximum non-homogeneous material hardness; and
coating a treated surface of the top plate and/or the side plate.

10. The method of claim 9, wherein selecting the coating material comprises selecting the coating material to have a hardness at least 1300 Hv.

11. The method of claim 10, wherein the coating material comprises a hardness at least 1500 Hv.

12. The method of claim 10, wherein the treated surface comprises the outside face of the side plate.

13. The method of claim 10, wherein the treated surface comprises the top face of the top plate.

14. The method of claim 10, wherein the treated surface comprises both the outside face of the side plate and the top face of the top plate.

15. The method of claim 10, wherein the coating material is further applied to a portion of the base portion that is in contact with another portion of the cutting chain.

16. The method of claim 10, wherein the coating material is further applied to a portion of the base portion that is in contact with a guide bar of the chainsaw.
